(19) United States
(12) Patent Application Publication
(10) Pub. No.: US 2013/0142014 A1
(43) Pub. Date: Jun. 6, 2013

(54) ELAPSED TIMEKEEPING WITH HYBRID DIGITAL-ANALOG TIME DISPLAYS

(71) Applicants: Berj A. TERZIAN, Newbury, MA (US); Robert Alfred BRODMANN, North Bergen, NJ (US)

(72) Inventors: Berj A. TERZIAN, Newbury, MA (US); Robert Alfred BRODMANN, North Bergen, NJ (US)

(73) Assignee: EQUITIME, INC., Newbury, MA (US)

(21) Appl. No.: 13/312,661

(22) Filed: Dec. 6, 2011

(51) Int. Cl. G04C 19/00; G04B 19/24

(52) U.S. Cl. 368/29; 368/82

(57) ABSTRACT

Elapsed timekeeping is enabled with hybrid digital-analog displays which portray hours and incremental elapsed minute values, as well as simultaneous analog tracks that are coordinated in lengths with the minute values. These displays are shown in four successive quadrants and enable users to view current time exactly from the digital values and approximately from the analog tracks.

### BACKGROUND OF THE INVENTION

1. Field of the Invention

This invention relates to new time displays which are composites of digital and analog elements that portray time in a manner that provides unique simplicity, balance and readability.

2. Description of the Prior Art

Cosmologists say that time began from the Big Bang about 13.7 billion years ago. Billions of years afterwards, humans began to evolve, and eventually started resorting to ways for keeping track of time. Examples are the shadows of sticks in the ground, sundials, hour glasses, cracks in stones and rocks, the cycles of sun/moon rise and set, ebb and flow of tides, and the sun's seasonal oscillations.

Several hundred years ago, the first pocket watch was invented, followed by wristwatches, initially analog, then digital, and today myriads of style and functions are extant. The time industry annually produces a large range of timepieces from cheap throwaways to expensive models costing tens to hundreds or even thousands of dollars. Sales also generate a few billions dollars yearly.

All people live for a lifetime, i.e., a finite amount of time. This is the most precious existence one can have. Therefore, time must be used carefully, satisfactorily, and successfully. The raison d'etre for achieving these goals is the engine that has driven production of countless styles and types of time displays and timepieces.

### SUMMARY OF THE INVENTION

The present invention creates a composite of digital and analog elements which have been coordinated with each other. This system achieves simplicity, balance and immediate readability to enable tracking elapsed time with unprecedented efficiency, satisfaction and confidence.

Other features and details of the invention will be understood from the following drawings and specific descriptions thereof.

### DESCRIPTION OF THE DRAWINGS

FIG. 1 is an initial drawing of a wristwatch that depicts a first phase of the present invention.

FIG. 2 is a second drawing that depicts a second phase.

FIG. 3 is a third drawing that depicts a third phase.

FIG. 4 is a fourth drawing that depicts a fourth phase.

### DETAILED DESCRIPTION OF THE INVENTION

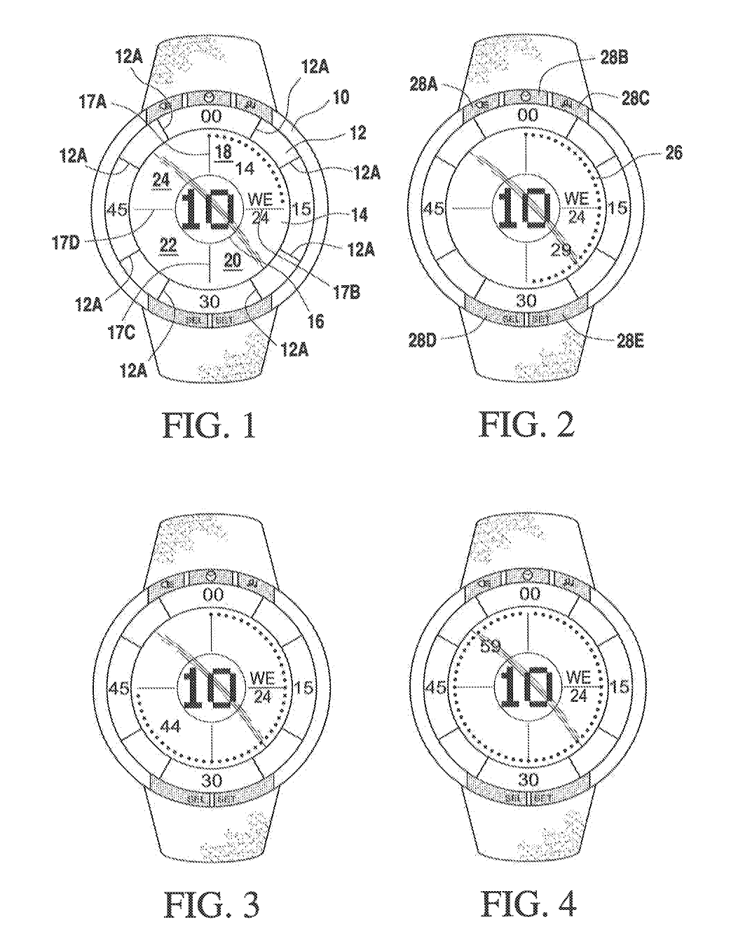

FIG. 1 depicts a wristwatch that preferably has a circular case 10, a circular bezel 12 and a circular dial 14. At the center of dial 14 is a smaller concentric circle 16 within which the hour “10” is displayed.

The vertical and horizontal line segments 17A, 17B, 17C and 17D extending between the bezel 12 and the concentric circle 16 divide dial 14 into four curved quadrants 18, 20, 22 and 24 respectively.

Bezel 12 is inscribed at the top with a double zeros mark “00”. Horizontal and vertical edges of bezel 12 are inscribed with minute values 15 on the right, 30 at the bottom, and 45 on the left. The four quadrants 18, 20, 22 and 24 are bordered by four curved bezel segments, each of which of which is inscribed with two short equally spaced radial line segments 12A which divide each quadrant into 5 minute locations, see FIG. 2.

Adjacent the curved inner bezel border segments are a series of small dots 26, see FIG. 2. These marks are analog LCD minute pixels each being equivalent to and coordinated with a minute location and value. These pixels create analog tracks of the progression of time values, as will be explained below.

FIG. 1 depicts the beginning of hour 10, with 00 minutes. When the first minute is reached, minute value 01 appears in the approximate center of quadrant 18. Simultaneously, the first pixel 26 appears adjacent the curved inner border of bezel 12. Thus, the first minute after hour 1 is both digitally defined and also pixelated as the initial step of a corresponding and coordinated analog tracks.

From this point on, all subsequent values of up to 15 minutes are displayed at the stationary central location of quadrant 18, with the coordinated appearances of the corresponding pixels 26. Thus, a lengthening curved set of the pixels 26 at the inner rim of bezel 12 function as analog tracks of the completion of the first quarter of hour 10. The specific time displayed in FIG. 1 is 14 minutes past 10.

FIG. 2 similarly displays the next quarter hour that begins with minute 16 in the stationary central location of quadrant 20 with the corresponding coordinated pixels 26. These progressive minute values continue until the completion of minutes 16 to 30 are displayed, as well as the corresponding thirty pixels that form analog tracks marking the completion of the first half hour by quadrants 18 and 20. The specific time displayed in FIG. 2 is 29 past 10.

FIG. 3 illustrates the analog track lengthened into the third quadrant 22 with the specific time being 10:44.

FIG. 4 displays the completed analog tracks in the fourth and last quadrant with the specific time of 10:59

The principal features of the invention have been portrayed and explained. The dial 14 is divided into four curved quadrants. Each quadrant is successively activated to display the current time, while the other three are empty, but also geometrically outlined by the quadrant cross border lines, 17A, 17B, 17C, and 17D.

The analog tracks cross into and through the four successive quadrants 18, 20, 22 and 24. All of the time values are minutes elapsed past the current hour 10.

The above noted features provide animation to the stationary digital values. Therefore, this system of digital exactitude, coordinated with graphic analog approximation, provides time displays that are very useful for virtually all conceivable timekeeping needs during normal daily tasks or play. It should also be noted that the first two quadrants display the day name and date, specifically Wednesday, i.e.(“WE”) and the current month's 24^{th} day, which are frequently useful to know.

In 2006, applicants' assignee, Equitime, Inc, introduced a new digital watch called QUADTEC. It was operated with five push buttons 28A, 28B, 28C, 28D and 28E marked with identifying icons, namely; 28A, a lamp emitting light beams (for lighting the display in the dark); 28B, a watch face showing 10 past 10 (for switching the display into a setting mode); 28C, a three tone musical melody (for switching the display into an alarm setting mode), and two more buttons marked with SEL and SET (for selecting and setting time modes and values), see FIG. 3. Similar buttons and functions are included in drawings of the present invention. These buttons and their operation are described in more detail in U.S. Pat. No. 7,187,624, which is incorporated herein by reference.

Manufacture of a module for the above described watch face can be readily accomplished by preparing an object code and then programming it into the ROM of a silicon LCD chip. The same technique was used in manufacturing the previous OUADTEC watch in 2006.

The invention has been described by its functional principles and specific embodiments. Many variations of this disclosure will be obvious to those skilled in the prior art. Therefore, it should be understood that the ensuing claims are intended to cover all changes and modifications of the illustrative embodiments which fall within the literal scope of the claims and all equivalents thereof.

1. Elapsed timekeeping with hybrid time displays comprising
(a) digital elements which generate and display hour and elapsed minute values during each current hour; and
(b) mobile analog elements which generate and display graphic analog tracks in lengths coordinated with the magnitudes of the minute values, said tracks being displayed solely upon the appearance and the location and the value of each minute.

2. Displays as in claim 1, wherein the tracks progress longer as the minute values rise from zero to 59.

3. Displays as in claim 1 wherein the tracks are one-by-coordinated to each minute values.

4. Displays as in claim 3, wherein all of the time values are surrounded by each track during each hour.

5. A wristwatch provided with a hybrid time display comprising:
(a) a circular case, a circular bezel and a circular dial;
(b) a smaller concentric circle positioned approximately in the center of the dial which displays hour values;
(c) vertical and horizontal cross lines between the concentric circle and the bezel which divide the dial into four curved quadrants; and
(d) hour and elapsed minute values traverse successively through the four quadrants to display a current hour and 59 elapsed minutes with an analog track surrounding the time values.

6. wristwatches as in claim 7, wherein the day name and day date are displayed respectively in the first two qauadrants.

7. A timepiece face having included analog elements.

8. The face of claim 7, wherein
the analog elements comprise multiple visible marks positioned on the face in a predetermined pattern.

9. The face of claim 8, wherein
the predetermined pattern comprises a track having directional shape.

10. The face of claim 9, wherein
the directional shape is circular.

11. The face of claim 9, wherein
the circular track is positioned adjacent the perimeter of the face.

12. The face of claim 11, wherein
each mark is brought into appearance in conjunction and coordination with each minute of time.

13. The face of claim 8, wherein
each mark is an electronic pixel.

14. A method of coordinating digital time values with analog elements comprising:
(a) providing digital hour and minute time values on a timepiece face; and
(b) displaying mobile marks on the face solely upon the appearance and the location and value of each minute,
thereby solitary analog representations of the current time.

15. A method as in claim 15, wherein
the marks are electronic pixels
